(19) United States
(12) Patent Application Publication
(10) Pub. No.: US 2009/0053570 A1
(43) Pub. Date: Feb. 26, 2009

(54) FUEL CELL STACK FOR LOW TEMPERATURE START-UP AND OPERATION

(76) Inventors: Binglun TIAN, Shanghai (CN); Hui DONG, Shanghai (CN)

Correspondence Address: MATTHIAS SCHOLL, 14781 MEMORIAL DRIVE, SUITE 1319, HOUSTON, TX, 77079, US

(21) Appl. No.: 12/233,714

(22) Filed: Sep. 19, 2008

Related U.S. Application Data
(63) Continuation of application No. PCT/CN2007/001236, filed on Apr. 16, 2007.

(30) Foreign Application Priority Data
Apr. 26, 2006 (CN) 200610026051.7

(51) Int. Cl. H01M 8/04

(52) U.S. Cl. 429/26

(57) ABSTRACT

A fuel cell stack without a terminal plate for low temperature starting operation, comprising: a plurality of membrane electrodes, a plurality of bipolar plates, at least one pair of current collecting lead boards, at least one electrical insulating partition boards, and two fastening rings. One electrical insulating partition board and one pair of current collecting lead boards serve to form one set of current output mechanism. The plurality of membrane electrodes, the plurality of wedge-shaped bipolar plates, and the at least one set of current output mechanism form a cylindrical fuel cell stack tightened by the two tightening rings. The cell stack is suitable for cold starting and for operation at temperatures below 0° C.

### CROSS-REFERENCE TO RELATED APPLICATIONS

This application is a continuation of International Patent Application No. PCT/CN2007/001236 with an international filing date of Apr. 16, 2007, designating the United States, now pending, and further claims priority benefits to Chinese Patent Application No. 200610026051.7 filed Apr. 26, 2006. The contents of all of the aforementioned applications, including any intervening amendments thereto, are incorporated herein by reference.

### BACKGROUND OF THE INVENTION

1. Field of the Invention

The invention relates to a fuel cell stack, and more particularly, to a fuel cell stack free of a terminal plate for low temperature starting and operation.

2. Description of the Related Art

The research into cold starting and low temperature operation of fuel cell is on the forefront of international fuel cell research because the cold starting performance of fuel cells influences directly their practicality and range of applications.

For conventional fuel cell stacks to generate power, water humidification is needed. Water is also required for cooling the fuel cell stack. Therefore at temperatures below 0° C., it is very difficult to cold start and operate fuel cells. If water management of fuel cell stacks fails at temperatures below 0° C., the cell system cannot be started normally. Water freezing in the cell system generally results in permanent and irreversible damage.

U.S. Pat. No. 6,699,612 discloses a cell system, wherein a cyclic antifreeze glycol is utilized for cooling. At the same time, the refrigerant also serves to mix with fuel gas in the heat exchanger to dry the fuel. A dewatering mechanism is also added in the system to remove water from the refrigerant to ensure a certain concentration of the refrigerant and prevent its freezing. It is clear that this system is relatively complex.

U.S. Pat. No. 6,727,013 discloses a method for maintaining the temperature of a fuel cell, wherein the fuel cell device is mainly utilized to keep the temperature at a standby status, and an external heating system is utilized to heat the fuel cell stack. A resistance load is firstly applied to generate heat, and then a fan is utilized to blow the heat air over the fuel cell stack. It is observed that energy has to be consumed continuously in the system in order to keep the temperature of the fuel cell stack. Moreover, the patent does not provide any information as to low temperature starting of the fuel cell.

U.S. Pat. No. 6,746,789 discloses a solution by utilizing an external catalytic reactor, wherein hydrogen is combusted in air to generate heat and water at low temperature to supply the air cathode or anode. By utilizing air as oxidant and refrigerant in the fuel cell system, the cell system is simplified and the low temperature starting performance is increased. However, the system is also complicated.

U.S. Pat. No. 7,014,935 discloses a method for solving the existing problem for two end cells of the fuel cell stack. During operation, and especially during low temperature starting operation, water and heat of the two end cells of the fuel cell stack is usually distributed non-uniformly. The end cells are processed to improve the anti-corrosion performance of the cell so as to improve the low temperature operability of the cell stack. However, the patent only discloses a method to improve the anti-corrosion performance of the end cells, and basically fails to solve the non-uniform water and heat distribution of the two end cells of the fuel cell stack.

U.S. Pat. No. 6,764,786 discloses a special lead board and terminal plate for fuel cell stack. The terminal plate of fuel cell stack is normally made of thick metal, is heavy and expensive, and has high heat capacity and is easy to transfer heat. When operating or starting at low temperature, the cells around the terminal plate are easy to lose heat, influencing the low temperature starting speed of fuel cell, and it is easy to cause back pressure, resulting in permanent damage. The patent discloses that a high strength, low heat capacity, and low heat loss terminal plate partially solves the problems of fuel cell stack caused during low temperature starting and operation.

U.S. Pat. No. 6,824,901 discloses a method utilizing porous heat insulation board between the end cell and the terminal plate of the fuel cell stack to solve the problems caused by low temperature cold starting. The heat insulation board is made of porous graphite board with the porosity of 50-75%. However, the heat insulation effect is limited, and the heat transfer from the end cell to the terminal plate is only partially blocked, so that the problem of the low temperature quick start-up of the fuel cell system is only partially solved.

U.S. Pat. No. 5,595,834 discloses a cylindrical cell stack, wherein the polar plate of each cell is circular, and the insulation plate of each cell extends over a certain distance to dissipate heat. However, the cell system of the invention has a relatively large size, and there is water and heat imbalance between end cells and internal cells, especially at relatively low temperatures.

U.S. Pat. No. 5,470,671 discloses a cylindrical fuel cell stack, wherein all the cathode sides of the cells are located on the circumference of the cell device to dissipate heat to the atmosphere. Since the conventional cell stack structure cannot be applied, the size of the cell system is relatively large, the cell voltage is low, and the cell power is small.

U.S. Pat. No. 5,595,834 discloses a compact cylindrical fuel cell stacked from cell polar plates and cells together. Due to the problem of heat dissipation, it is difficult to operate the cell system at high environmental temperature. Due to the existence of end cells, the problem of water and heat imbalance when starting at low temperature exists as well, which negatively influences the low temperature starting performance of the system.

To sum up, solutions to improve the low temperature starting performance of fuel cell mainly include: changing antifreeze medium; adding external heating process; processing specially the end cells of cell stack, or improving the water and heat management of the cell stack. Particularly, the water and heat balance of the end cells have a big influence on the low temperature quick cold starting of the fuel cell.

For the low temperature cold starting of fuel cell, the most simple and ideal method would be to add fuel hydrogen and air directly into the fuel cell system and to operate the cell at relative low voltage. The fuel cell stack can be heated quickly by the heat generated by the cell itself and thereby can realize low temperature cold starting without any assistance of external auxiliary heating device. In fact, decreasing water humidification of the fuel cell system is a good solution to realize low temperature starting. As disclosed by U.S. Pat. No. 6,746,789, decreasing humidification and adopting air to cool the fuel cell can simplify the complexity of the fuel cell system.

However, by utilizing air to cool the fuel cell, the power density of the cell stack is low, and the power range is small. Generally, the power range can only up to several hundred Watt; a kilowatt fuel cell is not easy to make. The integration of large air-cooling fuel cell stack is complex, and the system power is normally in a range of 100 to 150 W/L. It is even difficult to integrate large air-cooling fuel cell stack with a power in the range of kilowatt to tens of kilowatt. Therefore, large fuel cell mainly adopt water or refrigerant as cooling medium. Moreover, normal air-cooling fuel cell also has the water and heat balance problem at the end cells.

### SUMMARY OF THE INVENTION

Therefore, it is one objective of the present invention to provide a fuel cell stack free of terminal plate for low temperature starting operation to solve the above problems.

To realize the above objective, provided a fuel cell stack free of terminal plate for low temperature starting operation, comprising: a plurality of membrane electrodes, a plurality of bipolar plates, at least one pair of current collecting lead boards, at least one electrical insulating partition boards, and two fastening rings.

The bipolar plate is a wedge-shaped bipolar plate with an air flow field, a hydrogen flow field, and a cooling fluid flow field set thereon.

One set of current output mechanism can be formed by locating one electrical insulating partition board between one pair of current collecting lead board.

The plurality of membrane electrodes, the plurality of wedge-shaped bipolar plates, and the at least one set of current output mechanism form a cylindrical fuel cell stack tightened by the two tightening rings.

A top cover plate and a bottom cover plate are connected with the upper and lower shaft ends of the cylindrical fuel cell stack respectively.

The electrical insulating partition plate has a planar structure or a wedge-shaped structure with a thickness of 0.01-3 mm.

The top cover plate and the bottom cover plate are set with hydrogen and/or air and/or cooling fluid flow chambers and corresponding fluid outlets and inlets.

In a class of this embodiment or in another embodiment of the invention, the wedge-shaped bipolar plate can be a one-piece wedge-shaped bipolar plate, or is formed by integrating two pieces wedge-shaped single polar plates, or is formed by integrating one piece wedge-shaped single polar plate with one piece planar single polar plate, or is formed by integrating two pieces of planar single polar plates and one piece wedge-shaped plate.

In a class of this embodiment or in another embodiment of the invention, the wedge-shaped bipolar plate is made of one or two types of metal plate, graphite plate, or a flexible graphite plate.

In a class of this embodiment or in another embodiment of the invention, the fuel cell stack comprises one set of current output mechanism located between the first piece single cell and the last piece single cell of the cylindrical fuel cell stack.

In a class of this embodiment or in another embodiment of the invention, the fuel cell stack comprises at least two or more sets of current output mechanism located at different positions of the cylindrical fuel cell stack to distribute uniformly the multiple single cells of the fuel cell stack into at least two or more cell sets correspondingly.

In a class of this embodiment or in another embodiment of the invention, the internal orifice of the tightening ring comprises a straight orifice and a bellmouth orifice. The two tightening rings serves to house tightly the two ends of the cylindrical fuel cell stack respectively, and are pulled tightly through multiple sets of tightening nuts and screws. The gradual retracted circular face of the bellmouth orifice of the tightening ring is utilized to house the end portion of the cylindrical cell stack into the straight orifice to tighten the multiple membrane electrodes and multiple bipolar plates of the cell stack.

In a class of this embodiment or in another embodiment of the invention, the internal orifice of the tightening ring is a straight orifice. The two tightening rings serve to house directly the two ends of the tightened cylindrical fuel cell stack respectively.

In a class of this embodiment or in another embodiment of the invention, the thickness of the wedge-shaped bipolar plate adjacent to the current collecting lead board is less than those of other wedge-shaped bipolar plates.

In a class of this embodiment or in another embodiment of the invention, the outer surface of the cylindrical fuel cell stack is covered with a ring of air filters. The outer side of the circular top cover plate is installed with a fan.

As a result, the fuel cell stack free of terminal plate for low temperature starting operation of the invention provides the following advantages and characteristics.

1) The fuel cell stack utilizes compact tightening rings to replace the heavy cell terminal plate of conventional cell stack, and thus is light and handy.

2) The wedge-shaped bipolar plate of the cell stack is different from the planar shaped bipolar plate of a conventional fuel cell. One piece electrical insulating partition board is located between one pair of current collecting lead boards to form one set of current output mechanism. The two current collecting lead boards are located closely and are only separated by an electrical insulating partition board. At least one set of current output mechanism is generally set in the cell stack. The current increasing and voltage decreasing of the cell stack are easy to realize, and the system is characterized by high integration density.

3) The various portions of the membrane electrodes of the cell stack are stressed uniformly and thus are not prone to deformation. Owing to the strength of terminal plate, a certain degree of terminal plate deformation is existed on the conventional fuel cell stack, so that the membrane electrodes of conventional cell stack are non-uniformly stressed in the planar direction.

4) The water and heat balance of the end electrodes of the cell stack is optimal and is consistent with other internal electrodes, so that the cell stack is suitable for cold starting and operation under a temperature of below 0° C.

5) The launder of the air-cooling cell stack is generally in a structure of wedge, so that the air resistance of the air-cooling launder can be reduced, the air cooling heat transfer area can be increased, and the heat exchange and the uniformity of thermal distribution in the cell stack is improved.

6) The power range of the cell stack can be extended rapidly. The power is in a relationship of third power with respect to the size. For example, if the power for a cell with a diameter of 8 cm and a height of 8 cm is 120 W, the power for a cell with a diameter of 16 cm and a height of 16 cm can reach up to 1 kW, and the power for a cell with a diameter of 32 cm and a height of 32 cm can reach up to 8 kW. The structure of the cell stack and its system is compact, and a high power density can be kept within a wide power range. The power of a conventional cell stack can normally increase in one-dimensional direction, but the integration degree when increasing in two- or three-dimensional directions will be decreased.

7) The wedge-shaped bipolar plates are compressed tightly together with the membrane electrodes, in combination with the special wedge-shaped structure, so that the cell stack has a strong capability against influence of external forces such as vibration or impacts.

8) The launder of the wedge-shaped bipolar plate is normally a through launder having a very low manufacturing cost, and thus is suitable for mass production.

9) The membrane electrode is in a structure of normal rectangle, thus the material efficiency is high.

10) The air filter can be set directly outside of the cylindrical cell stack, offering a high degree of system integration.

### BRIEF DESCRIPTION OF THE DRAWINGS

The invention is described hereinbelow with reference to accompanying drawings, in which:

FIG. 1 is a perspective view of a fuel cell stack without a terminal plate for low temperature operation in accordance with one embodiment of the invention;

FIG. 2 is a perspective view of a wedge-shaped bipolar plate in accordance with another embodiment of the invention;

FIG. 3 is a perspective view of a set of current output mechanism in accordance with the invention;

FIG. 4 is an exploded view of a wedge-shaped bipolar plate in accordance with another embodiment of the invention;

FIG. 5 is a perspective view of a fuel cell stack for low temperature operation without a terminal plate in accordance with another embodiment of the invention; and

FIG. 6 is a basic structural view of a fuel cell stack and its auxiliary system in accordance with another embodiment of the invention.

### DETAILED DESCRIPTION OF THE EMBODIMENTS

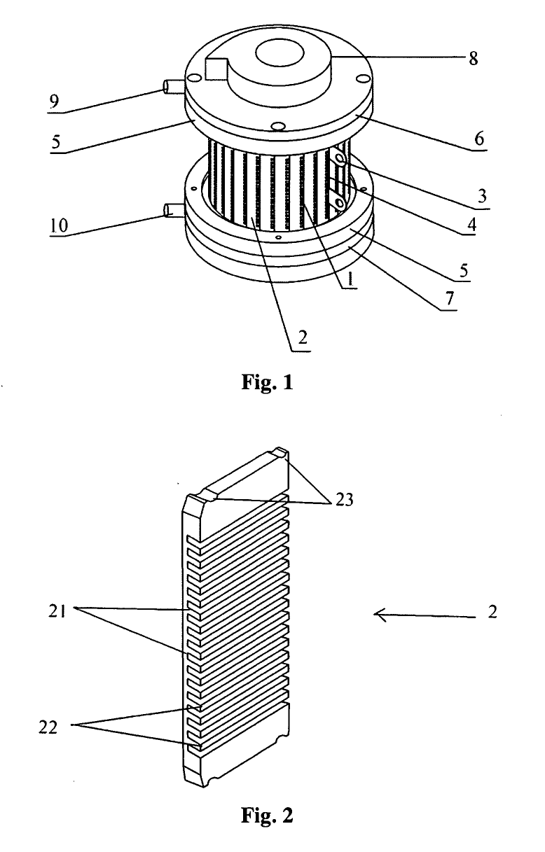

As shown in FIG. 1, a fuel cell stack without a terminal plate for low temperature starting operation, comprises: a plurality of membrane electrodes 1, a plurality of wedge-shaped bipolar plates 2, at least one pair of current-collecting lead boards 3, at least one electrical insulating partition boards 4, two tightening rings 5, a top cover plate 6, a bottom cover plate 7, and a centrifugal fan 8. The electrical insulating partition board 4 is located between one pair of current collecting lead boards 3 to form one set of current output mechanism. The plurality of membrane electrodes 1, the plurality of wedge-shaped bipolar plates 2, and the at least one set of current output mechanism are integrated together by two tightening rings 5 to form a cylindrical fuel cell stack. The top cover plate 6 and the bottom cover plate 7 are connected with the upper and lower shaft ends of the cylindrical fuel cell stack respectively. The electrical insulating partition board 4 has a planar structure or a wedge-shaped structure with a thickness of 0.05 mm (normally in a range of between 0.01 mm and 3 mm). A hydrogen flow chamber is set on both the top cover plate 6 and the bottom cover plate 7, a hydrogen inlet 9 is set at the side of the top cover plate 6, and a hydrogen outlet 10 is set at the side of the bottom cover plate 7. This embodiment comprises one set of current output mechanism located between the first piece single cell and the last piece single cell of the cylindrical fuel cell stack.

The wedge-shaped bipolar plate of the invention is made of one or two types of metal plate, graphite plate, or a flexible graphite plate. The wedge-shaped bipolar plate can be a one-piece wedge-shaped bipolar plate, can be formed by integrating two pieces of wedge-shaped single polar plates, can be formed by integrating one piece wedge-shaped single polar plate with one piece of planar single polar plate, or can be formed by integrating two pieces planar single polar plates and one piece wedge-shaped plate. The thickness of the wedge-shaped bipolar plate adjacent to the current collecting lead board can less than those of other wedge-shaped bipolar plates.

As shown in FIG. 2, the two sides of the wedge-shaped bipolar plate 2 are set with an air flow field and a hydrogen flow field, respectively. The air flow field comprises a plurality of radial through air flow launders along the surface of the wedge-shaped bipolar plate. The depth of multiple air flow launders can be set from shallow to deep according to the thickness of the wedge-shaped bipolar plate from thin to thick, or can be set uniformly. The hydrogen flow field comprises a plurality of axial through hydrogen flow launders along the surface of the wedge-shaped bipolar plate. As shown in FIG. 2, the air flow launder, the launder shoulder, and the seal slot are numbered as 21, 22, and 23, respectively, while the hydrogen flow launder is not visible.

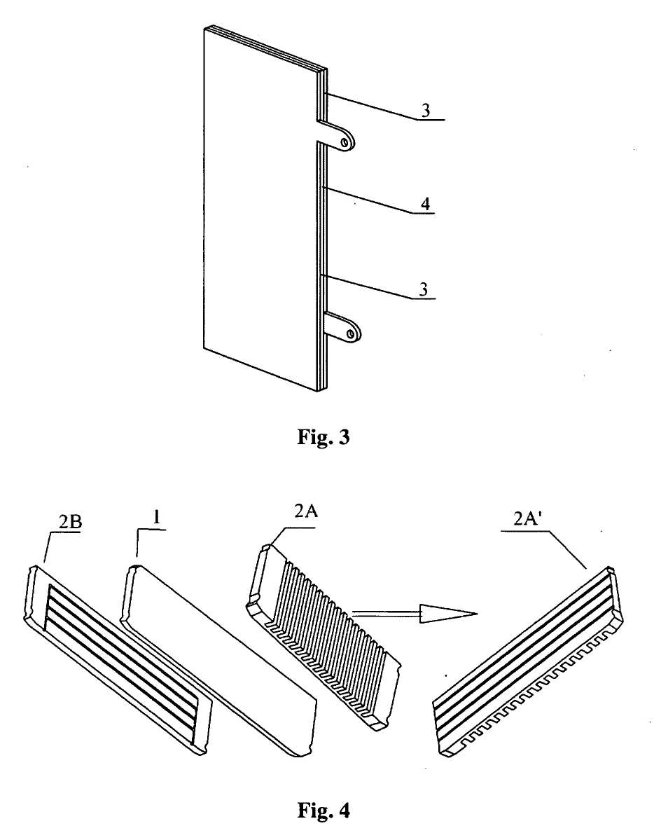

With reference to FIG. 3, the current output mechanism is formed by an electrical insulating partition board 4 located between one pair of the current output lead boards 3. The fuel cell stack comprises at least one set of such current output mechanism. If the fuel cell stack comprises one set of current output mechanism, the current output mechanism is set between the first piece single cell and the last piece single cell of the cylindrical fuel cell stack. If the fuel cell stack comprises at least two sets of current output mechanism, the two or more different sets of current output mechanism can be set at different positions on the cylindrical fuel cell stack respectively to distribute uniformly the multiple single cells of the fuel cell stack into corresponding two or more cell sets.

With reference to FIG. 4, the wedge-shaped bipolar plate 2 comprises two wedge-shaped single polar plates 2A and 2B. One side of the wedge-shaped single polar plate 2A is set with an reacting air flow field facing to the membrane electrodes, the other side is set with a cooling air flow field. One side of the wedge-shaped single polar plate 2B is set with a hydrogen flow field facing to the membrane electrode. The wedge-shaped single polar plate 2A in FIG. 2 is rotated a certain degree in order to display the reacting air flow field. When assembling, the side with cooling air flow field of the wedge-shaped single polar plate 2A is affixed to the side without flow field of the wedge-shaped single polar plate 2B.

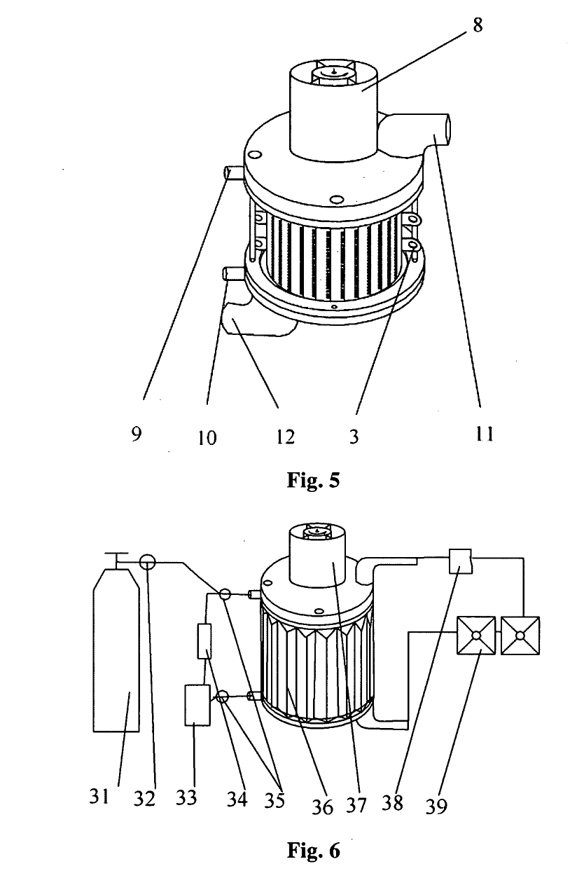

FIG. 5 is a three-dimensional view of a fuel cell stack without a terminal plate for low temperature starting operation in accordance with another embodiment of the invention. The bipolar plate illustrated in FIG. 4 is utilized in this embodiment. 200 pcs bipolar plates 2, the same amount of MEA, and two sets of current output mechanism (each set of current output mechanism comprises two current collecting lead boards 3 and one electrical insulating partition board) together serve to form a 10 kW hollow cylindrical fuel cell stack with an outer dimension of 340×340 mm and an inner dimension of 220×340 mm. The length of the bipolar plate is 340 mm, and the effective area of MEA is 180 cm². The cooling air flow launder is separated to the reacting air flow launder. The top cover plate 6 of the cell stack is set with a reacting air inlet 11 and is installed with a fan 8 for heat dissipation. The bottom cover plate 7 of the cell stack is set with a reacting air outlet 12. The cylindrical fuel cell stack comprises two sets of current output mechanism serving to distribute the fuel cell into two cell sets, contributing to a decrease the output voltage and an increase of the output current of the cell stack.

The structure of the tightening ring 5 of the invention can have two different types. For the first type, the internal orifice of the tightening ring comprises a straight orifice and a bellmouth orifice. When housing the tightening rings to the cylindrical fuel cell stack, the two tightening rings serve to house tightly the two ends of the cylindrical fuel cell stack respectively, and are pulled tightly by multiple sets of tightening nuts and screws. The gradual retracted circular face of the bellmouth orifice of the tightening rings is utilized to house the end portion of the cylindrical cell stack into the straight orifice part of the tightening rings to tighten the multiple membrane electrodes and multiple bipolar plates of the cell stack. For the second type, the internal orifice of the tightening ring is a straight orifice. When housing the tightening rings to the cylindrical fuel cell stack, the two tightening rings serve to house directly the two ends of the tightened cylindrical fuel cell stack respectively.

FIG. 6 shows a basic structural view of a fuel cell stack and its auxiliary system in accordance with the invention. The length of the bipolar plate of the fuel cell stack in this embodiment is 400 mm, and the effective area of MEA is 240 cm². 240 pieces of bipolar plates, the same amount of MEA, and one set of current output mechanism together serve to form a 25 kW cylindrical fuel cell stack. The auxiliary system comprises a hydrogen storage tank 31, a pressure reduction valve 32, a steam-water separator 33, a hydrogen cycling pump 34, an electromagnetic valve 35, an air filter 36, an air fan 37, a liquid cycling pump 38, a heat dissipating fin, and a heat dissipating fan 39. The air filter 36 is located around the cell stack and serves to surround the cell stack.

The power generation system comprised of the fuel cell stack of the invention without a terminal plate is tested for low temperature starting operation. The bipolar plate comprises two single polar plates. One of the single polar plates is made of planar flexible graphite plate, and the other is made of wedge-shaped graphite plate. The air flow launders capable of realizing both reacting and heat dissipating functions are set on the wedge-shaped graphite plates. 80 pieces of bipolar plates, the same amount of MEA with an effective area of 52 cm², and one set of current output mechanism together serve to form a 1.2 kW hollow cylindrical fuel cell stack with an outer dimension of 180×160 mm and an inner dimension of 100×160 mm. The test process for low temperature cold operation is as described below: (1) opening the hydrogen input and output electromagnetic valves through a control circuit board at a cold starting temperature of −18° C.; (2) closing the hydrogen outlet electromagnetic valve after the cell stack is filled with hydrogen; (3) driving the fan by the enough electrical energy generated by the cell stack to operate to supply the minimum air amount required for reaction; (4) inputting large load to the fuel cell to keep the voltage of the single cell at 0.2V and to provide instant short-circuit operation; and (5) generating a sufficient amount of heat by the cell stack to increase the temperature of the cell stack rapidly to above 0° C. within 30 seconds. The low temperature cold starting of the cell stack was performed for more than 100 times, the cells operated normally, and no cell performance decrease was observed.

This invention is not to be limited to the specific embodiments disclosed herein and modifications for various applications and other embodiments are intended to be included within the scope of the appended claims. While this invention has been described in connection with particular examples thereof, the true scope of the invention should not be so limited since other modifications will become apparent to the skilled practitioner upon a study of the drawings, specification, and following claims.

All publications and patent applications mentioned in this specification are indicative of the level of skill of those skilled in the art to which this invention pertains. All publications and patent applications mentioned in this specification are herein incorporated by reference to the same extent as if each individual publication or patent application mentioned in this specification was specifically and individually indicated to be incorporated by reference.

The invention claimed is:

1. A fuel cell stack without a terminal plate for low temperature starting operation, comprising:
a plurality of membrane electrodes,
a plurality of bipolar plates,
at least one pair of current collecting lead boards,
at least one electrical insulating partition boards, and
two fastening rings,
wherein
said bipolar plate is a wedge-shaped bipolar plate with an air flow field, a hydrogen flow field, and a cooling fluid flow field disposed thereon;
said at least one set of current output mechanism is formed by locating one electrical insulating partition board between said at least one pair of current collecting lead boards;
said plurality of membrane electrodes, said plurality of wedge-shaped bipolar plates, and said at least one set of current output mechanism form a cylindrical fuel cell stack tightened by said two tightening rings;
a top cover plate and a bottom cover plate are connected with the upper and lower shaft ends of said cylindrical fuel cell stack, respectively;
said electrical insulating partition plate has a planar structure or a wedge-shaped structure with a thickness of between 0.01 and 3 mm;
said top cover plate and said bottom cover plate are set with hydrogen and/or air and/or cooling fluid flow chambers and with corresponding fluid outlets and inlets.

2. The fuel cell stack of claim 1, wherein said wedge-shaped bipolar plate is a one-piece wedge-shaped bipolar plate, or is formed by integrating two wedge-shaped single polar plates, or is formed by integrating one piece wedge-shaped single polar plate with one piece planar single polar plate, or is formed by integrating two pieces of planar single polar plates and one piece of wedge-shaped plate.

3. The fuel cell stack of claim 1, wherein said wedge-shaped bipolar plate is made of one or of two types of the following: metal plate, graphite plate, or flexible graphite plate.

4. The fuel cell stack of claim 1, wherein the system comprises one set of current output mechanism located between the first piece single cell and the last piece single cell of said cylindrical fuel cell stack.

5. The fuel cell stack of claim 1, wherein the system comprises at least two or more sets of said current output mechanism located at different positions of said cylindrical fuel cell stack to distribute uniformly the multiple single cells of the fuel cell stack into at least two or more cell sets correspondingly.

6. The fuel cell stack of claim 1, wherein
the internal orifice of said tightening ring comprises a straight orifice and a bellmouth orifice;
said two tightening rings serve to house tightly the two ends of the cylindrical fuel cell stack respectively, and are pulled tightly by multiple sets of tightening nuts and screws;
the gradual retracted circular face of the bellmouth orifice of said tightening ring is utilized to house the end portion of said cylindrical cell stack into the straight orifice to tighten said multiple membrane electrodes and said multiple bipolar plates of said cell stack.

7. The fuel cell stack of claim 1, wherein the internal orifice of said tightening ring is a straight orifice, and said two tightening rings serve to house directly the two ends of the tightened cylindrical fuel cell stack, respectively.

8. The fuel cell stack of claim 1, wherein the thickness of said wedge-shaped bipolar plate adjacent to said current collecting lead board is less than the thickness of other wedge-shaped bipolar plates.

9. The fuel cell stack of claim 1, wherein the outer surface of said cylindrical fuel cell stack is covered with a ring air filter; and the outer side of said top cover plate is installed with a fan.
